(19) United States
(12) Patent Application Publication
(10) Pub. No.: US 2007/0274341 A1
(43) Pub. Date: Nov. 29, 2007

(54) Method and system for managing software image downloads to ONTs over a PON network

(75) Inventor: Ralph T. Rodriguez, Santa Rosa, CA (US)

Correspondence Address: THE SMALL PATENT LAW GROUP LLP, 611 OLIVE STREET, SUITE1611, ST. LOUIS, MO, 63101, US

(73) Assignee: TELLABS PETALUMA, INC.

(21) Appl. No.: 11/442,246

(22) Filed: May 26, 2006

(51) Int. Cl. H04J 3/24

(52) U.S. Cl. 370/473

(57) ABSTRACT

A method and system are provided for managing transfer of software images to ONTs over a PON network. The method includes dividing a software image into multiple segments, where each segment is divided into sections. The sections of each segment include at least one unacknowledged section and at least one acknowledged section. The method further includes downloading, over a common broadcast channel to a group of ONTs, the unacknowledged sections of a first segment. The unacknowledged sections are downloaded successively in an unacknowledged manner. The method further includes downloading, over unicast channel to corresponding ONTs within a group of ONTs, the acknowledged section of the first segment. Each of the ONTs in the group of ONTs returns of an acknowledgement or a non-acknowledgement in response to the acknowledged section downloaded from the OLT. The acknowledged or unacknowledged reply message is returned depending upon whether the corresponding ONT is properly received and recorded each section within a corresponding segment.

### BACKGROUND OF THE INVENTION

Embodiments of the present invention generally relate to methods and systems for managing transfer of software images within a PON, and more particularly to hybrid multicast, unicast transmission methods and systems for downloading software images to ONTs in a PON network.

Today, passive optical networks are utilized in a variety of applications. Passive optical networks (PONs) generally include at least one optical line terminal (OLT) that communicates with a parality of optical network terminals (ONTs). Standards have been set in place to manage communication over a PON network. For example, the ONT management and control interface standard as set forth in ITU 983.2 and 984.4 define an OMCI protocol that defines, among other things, the protocol for messages to be conveyed over the transport layer within the PON network. From time to time, it is desirable to upgrade or otherwise modify software images at the ONTs within a PON network. To affect an upgrade, a software image including the upgrade is conveyed to each ONT intended to receive the software image upgrade.

As the size and complexity of PON networks increases, the time required to implement an individual upgrade similarly increases. Heretofore, upgrade methodologies utilize either a unicast method or a pure-broadcast method. In the unicast method, each individual ONT is separately addressed and the complete software image is conveyed to the ONT over a corresponding unique channel. Thus, in PON networks having a large number of ONTs, the same software image was transmitted over the PON network numerous times, equal to the number of ONTs to be upgraded.

More recently, a pure broadcast method has been proposed in which the software image upgrade is entirely conveyed over a broadcast channel. Generally, software image upgrades are intended only for a group of the ONTs on the PON. As part of the management of the software upgrade, the network must ensure that the ONT has properly received the complete software image and is able to install and activate the software image before committing the ONT to use the software image thereafter. The proposed pure broadcast method has not addressed issues in connection with the need to redefine the OMCI protocol in a pure broadcast method. Thus, the OMCI protocol would need to be modified to support a pure broadcast method as the existing OMCI protocol does not provide for the acknowledgement of broadcast messages within the transport layer. Thus, when a software image is broadcast to multiple ONTs, the existing OMCI protocol does not provide for individual acknowledgement by the ONTs receiving the upgrade. Thus, a pure broadcast method would need to modify the OMCI protocol to support acknowledged broadcasts which would further increase software complexity at the transport layer.

A need remains for improved methods and systems for managing the transfer of software images to ONTs over a PON network.

### BRIEF DESCRIPTION OF THE INVENTION

In accordance with an embodiment, a method is provided for managing transfer of software images to ONTs over a PON network. The method includes dividing a software image into multiple segments and dividing each segment into multiple sections. The sections of each segment are designated such that at least one section constitutes an unacknowledged section and at least one section constitutes an acknowledged section. The method further includes downloading, over a common broadcast channel to a group of ONTs, the unacknowledged sections within a first segment of the software image. The unacknowledged sections are downloaded successively in an unacknowledged manner. The method further includes downloading, over unicast channels to corresponding ONTs within the group of ONTs, the acknowledged section of the first segment. Each of the ONTs in the group of ONTs returns an acknowledgement (ACK) or a non-acknowledgement (NACK) reply message in response to the acknowledged section. The acknowledgement or unacknowledgement reply message is returned depending upon whether the corresponding ONT has properly received and recorded each section of the corresponding segment.

In accordance with at least one embodiment, the method further includes configuring each of the ONTs with an OMCI broadcast channel and with an OMCI unicast channel, where the unacknowledged sections are conveyed over the OMCI broadcast channel, while the acknowledged section is conveyed over the OMCI unicast channel. Optionally, the last section (section N) within each segment may be designated as the acknowledged section. Thus, each ONT with the select group of ONTs that receives the software image only replies with an ACK or NACK reply message upon receipt of the N^{th} section. The method further includes identifying NACKed ONTs within the group of ONTs, where a NACKed ONT represents an ONT that did not properly receive all of the sections within the current segment. When a NACKed ONT is identified, the method includes re-downloading the complete segment, including all of the acknowledged and unacknowledged sections to the NACKed ONT. The re-downloading operation may be carried out as a complete unicast operation. Alternatively, the re-downloading operation may be carried out as a broadcast operation only directed to the NACKed ONTs, where all of the unacknowledged sections are rebroadcast, while only the acknowledged section is transmitted unicast.

In accordance with an alternative embodiment, a system is provided for managing transfer of software images to ONTs over a PON network. The system includes a control module that divides the software image into segments and divides the segments into sections, where each section is transmitted as a separate packet over an ODN network. The system further includes broadcast and unicast channel interfaces. The broadcast channel interface transmits sections of a first segment in unacknowledged manner over a broadcast channel to all of the ONTs. Prior to transmission, a select group of the ONTs is instructed listen to the unacknowledged sections over the broadcast channel. The unicast channel interface transmits, in an acknowledged manner, an acknowledged section of the first segment. The acknowledged section of the first segment is transmitted over separate unicast channels, each of which corresponds one of the select ONTs.

Optionally, each ONT may include a section counter that counts received sections of the segment, and include an ACK/NACK reply module that returns an acknowledgement or non-acknowledgement message depending upon whether all of the sections within the segment are properly counted. Optionally, each ONT may further include a NACK recover module that initiates a predefined recovery sequence to receive a segment of the software image that is transmitted. The recovery module may direct the unicast channel interface to receive the complete retransmitted segment. Alternatively, the NACK recovery module may direct the broadcast channel interface to receive all of the unacknowledged sections of the retransmitted segment while only the last section, representing the acknowledged section, of the segment is transmitted to the unicast channel interface.

### BRIEF DESCRIPTION OF THE DRAWINGS

FIG. 1 illustrates a block diagram of a PON network implementing software image downloads in accordance with an embodiment of the present invention.

FIG. 2 illustrates a block diagram of a manager module formed in accordance with an embodiment of the present invention.

FIG. 3 illustrates a block diagram of an ONT operated in accordance with an embodiment of the present invention.

FIG. 4 illustrates an instruction sequence for configuring channels on a PON network in accordance with an embodiment of the present invention.

FIG. 5 illustrates an instruction sequence for initiating a download operation in accordance with an embodiment of the present invention.

FIG. 6 illustrates an instruction sequence in connection with downloading a segment of a software image in accordance with an embodiment of the present invention.

FIG. 7 illustrates a processing sequence carried out in connection with a NACK message received from an ONT in accordance with an embodiment of the present invention.

FIG. 8 illustrates a processing sequence for activating and committing a software image in accordance with an embodiment of the present invention.

### DETAILED DESCRIPTION OF THE INVENTION

FIG. 1 illustrates a block diagram of a passive optical network (PON) 10 formed in accordance with an embodiment of the present invention. The PON 10 includes an optical line terminal (OLT) 12 joined through an optical distribution network (ODN) 14 to a plurality of optical network terminals (ONTs) 16. The ODN 16 includes at least one passive optical splitter that, for downstream communications, splits optical data bursts between multiple ONTs 14. The passive optical splitter combines, for upstream communications, any overlapping or simultaneously received data bursts. During initialization, the OLT 12 distributes a map identifying a time division multiplexing (TDM) transmission scheme, in which each ONT 16 is assigned one or more upstream channels (e.g., time slots) during which the ONT 16 may uniquely transmit optical data bursts upstream to the OLT 12. Each ONT 16 is also assigned one or more downstream channels (e.g., time slots) during which the OLT 12 transmits data packets directed to the corresponding ONT 16.

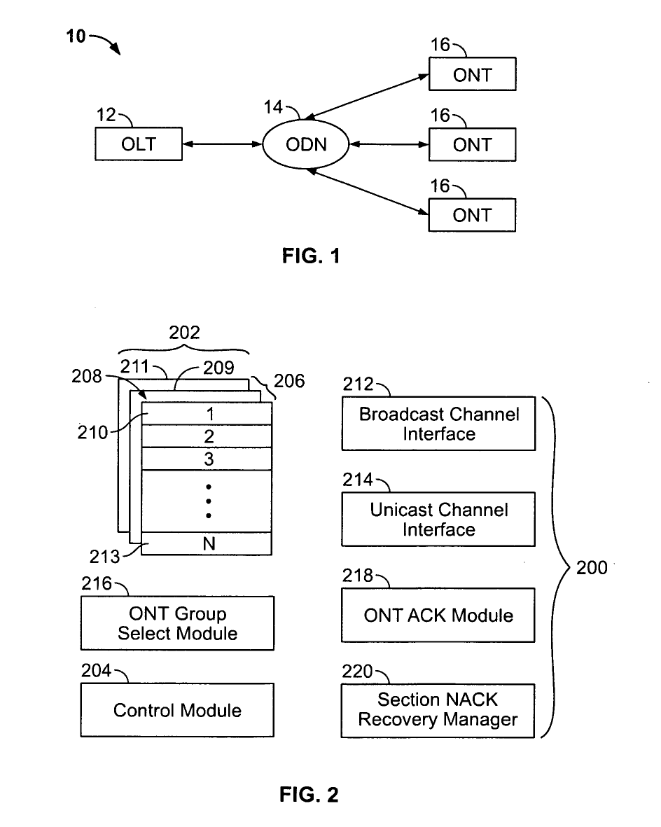

FIG. 2 illustrates a block diagram of a download manager 200 implemented in accordance an embodiment of the present invention. The download manager 200 may be implemented separate from, or as part of, an optical line termination (OLT). The download manager 200 includes memory 202 for storing a software image to be transferred to one or more ONTs. A control module 204 manages the overall operation of the download manager 200. For example, the control module 204 may manage division of the software image 206, within memory 202, into segments 208 and the division of each segment 208 into sections 210. Each section 210 is downloaded during a single transmission. In the example of FIG. 2, each segment 208 is divided into N-sections 210. The manager 200 further includes a broadcast channel interface 212 and a unicast channel interface 214. The broadcast channel interface 212 manages conveyance of sections 210 over the broadcast channel of the PON network. The broadcast channel interface 212 downloads sections 210 of a first segment 208, followed by successive sections of segments 209 and 211 until a complete software image 206 is successfully downloaded to each of the ONTs, to which the software image 206 had been designated for download. The unicast channel interface 214 downloads, over corresponding unique or unicast channels, at least one acknowledged section 213 from each segment 208, 209 and 211. The section 213 is downloaded by the unicast channel interface 214 in an acknowledged manner.

An ONT group select module 216 determines which ONTs should receive and upload the software image 206. The ONT group select module 216 directs the manager 200 to send a start command to each ONT in the group via a corresponding unicast channel. The control module 204 waits for each of the ONTs within the group identified by the ONT group select module 216 to reply with an acknowledgement (ACK) reply message indicating that the ONTs have received the download start command and are ready to receive the sections and segments of a new software image. The ONTs may reply with an ACK or a not acknowledgement (NACK) reply message. For example, an ONT may reply with a NACK reply message when the ONT does not agree with the proposed section sizes and segment sizes. When a NACK reply message is received from an ONT in response to a download start command and the NACK message cannot be resolved by the manager 200, the ONT is removed from the group by the ONT group select module 216. Optionally, the ONT sending the NACK message may be separately upgraded alone or in a separate group. As a further option, the ONT may be individually upgraded by downloading the complete software image 206 in a standard unicast manner.

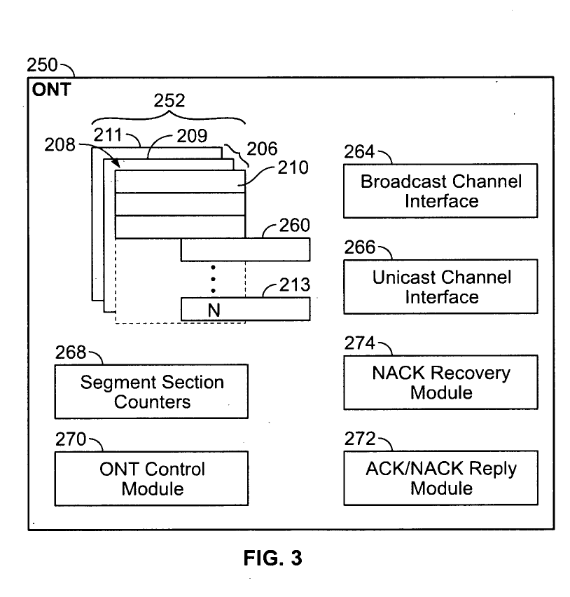

FIG. 3 illustrates a block diagram of an ONT 250. The ONT 250 includes the broadcast channel interface 264, a unicast channel interface 266, an ONT control module 270, a segment/section counter 268, an ACK/NACK reply module 727 and a NACK recovery module 274. The ONT 250 further includes memory 252 that is configured to receive the software image 206, such as during a downloading operation. The ONT control module 270 coordinates storage in memory 252 of each of the segments 208, 209, 211 of the software image 206. Each segment 208, 209, 211 is stored section by section 210, 213. The segment/section counters 268 keep track of the segments 208, 209, 211 and sections 210, 213 that are received and properly stored within memory 252. The ACK/NACK reply module 272 provides acknowledgement or not acknowledgement reply messages or responses to those incoming commands received over the unicast channel interface 266 from the OLT 200. The NACK recover module 274 implements a predetermined NACK recovery process when it is determined by the ONT control module 270 that a segment 208, 209, 211 has not been properly stored in memory 252.

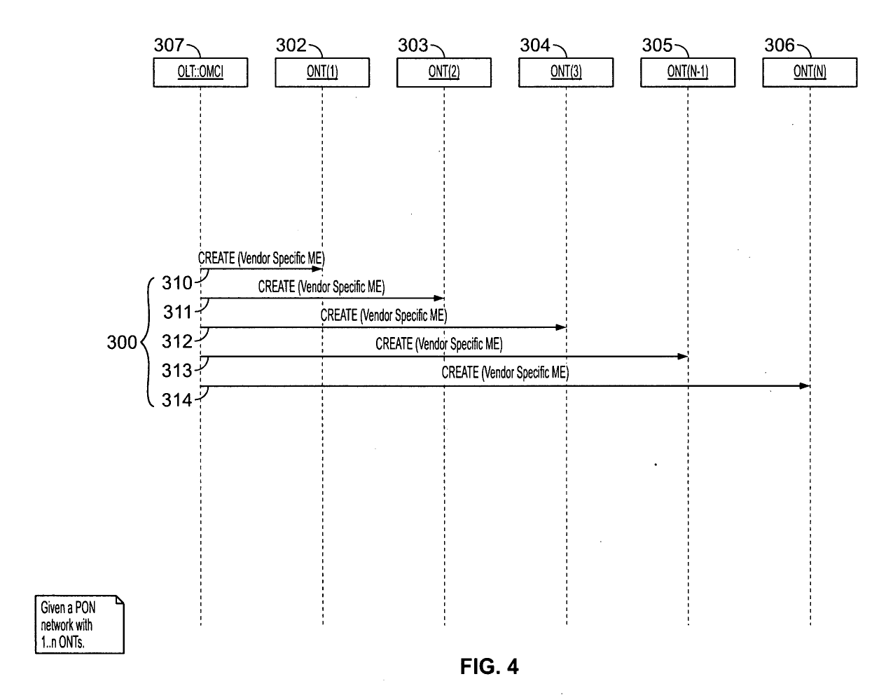

FIG. 4 illustrates an instruction sequence 300 carried out in accordance with an embodiment of the present invention to configure ONTs by designating a broadcast channel to convey a software image download in accordance with an embodiment of the present invention. The instruction sequence 300 informs all of the ONTs 302-306 on the ODN of a broadcast channel. The ONTs 302-306 will thereafter expect sections of a software upgrade over the designated broadcast channel. When the ONTs 302-306 are added to the network, each ONT 302-306 receives a broadcast channel create instruction 310-314, respectively. The instruction 310-314 direct the ONTs 302-306 to monitor the common broadcast channel, over which broadcast messages will be conveyed in accordance with the OMCI standard. The broadcast channel is used to convey unacknowledged OMCI messages which include unacknowledged sections 210 of segments 208, 209, 211 of a software image 206. The instruction 310-314 may vary based on the vendor of the ONT 302-306. The manner by which the broadcast channel is configured on each ONT 302-306 may differ, depending upon the vender specific mechanical entity over which the ONT 302-306 is joined to the network at the physical layer. As shown in FIG. 4, the OLT 307 separately conveys the instructions 310-314 to each of the ONTs 302-306.

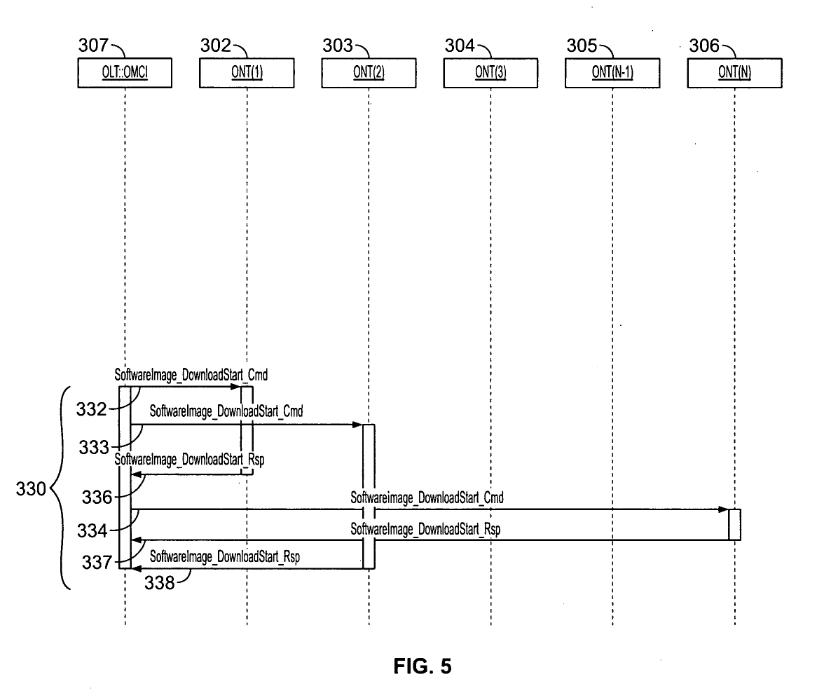

FIG. 5 illustrates an instruction sequence 330 that is preformed at the direction of the ONT group select module 216 (FIG. 2) and control module 204 in order to inform a group of ONTs (e.g., 302, 303 and 306) to prepare to receive a new or upgraded software image (e.g., 206). Download start commands 332-334 are conveyed, along unicast channels, to the ONTs 302,303 and 306, respectively. The ONTs 302, 303 and 306 provide download start responses 336-338 indicating that each of the ONTs 302, 303 and 306 have received the download start command and are now ready to begin receiving the sections of a new or upgraded software image. Following reception of a download start command, the ONTs 302, 303 and 306 begin monitoring the broadcast channel for the software image. In the example of FIG. 5, the ONTs 304-305 are not in the selected ONT group. Thus, the ONTs 304 and 305 did not receive download start commands and are not instructed to participate in an upgrade or download of a software image. While the sections 210 of the software image 206 will be visible to the ONTs 304 and 305, the ONTs 304 and 305 will ignore the incoming software image on the broadcast channel.

Download of the software image 206 commences after all of the ONTs in the select ONT group have replied with an acknowledged download start response. In FIG. 5, the download start commands 332-334 and download start responses 336-338 are shown in a temporal manner (running from the top to the bottom of FIG. 5), such that download start command 332 is transmitted first, followed by download start command 333, etc. However, it is understood that the download start commands may be transmitted in any order and that the download start responses may be received in any order after or interleaved with the download start commands.

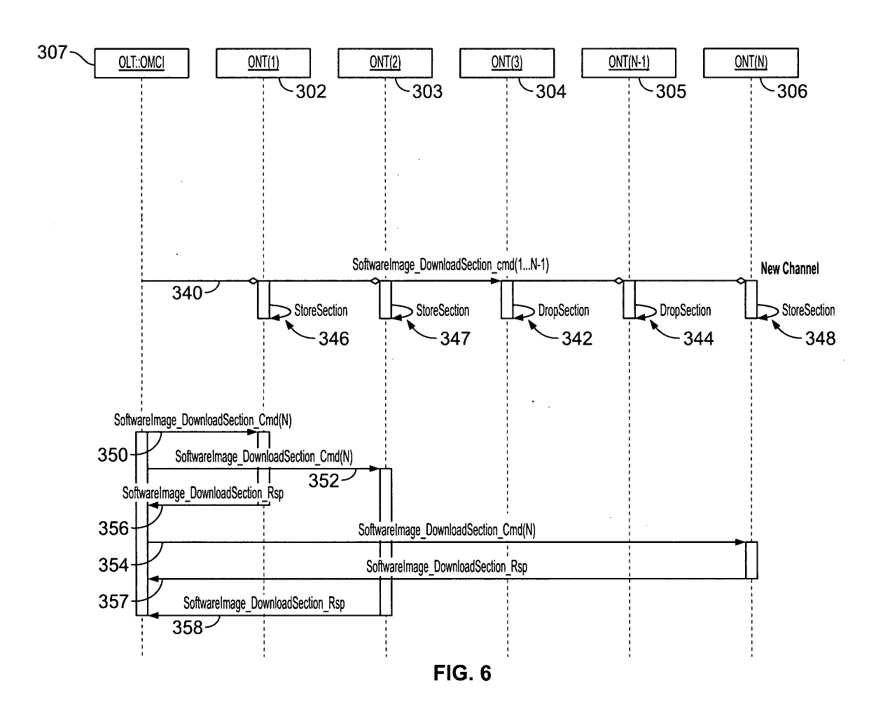

FIG. 6 illustrates an instruction sequence carried out in connection with downloading the software image 206. The broadcast channel interface 216 (FIG. 2) begins broadcasting successive sections 210 of the first segment 208 as section packets 340 over the common broadcast channel. The section packets are visible to all of the ONTs 302-306. ONTs 304 and 305 have not been instructed to receive the software image 206 and thus drop the section packets 340 as noted at 342 and 344. The ONTs 302, 303 and 306, are within the select group of ONTs to receive the software image and thus successively store the section packets 340 of sections 210 of the software image 206 (as denoted at 346-348).

Each section packet 340 conveyed over the broadcast channel, includes a number identifying the position of the section 210 within the corresponding segment 208. The ONTs 302, 303 and 306 keep track of the received sections 210 at the segment/section counters 268 (FIG. 3). The section packets 340 conveyed over the broadcast channel in accordance with an unacknowledged protocol, and thus the ONTs 302, 303 and 306 do not reply with any type of acknowledgement message upon received of each section packet 340. In the example of FIG. 2, only the N^{th} section 213 has been designated to constitute an acknowledged section. Thus, sections 1 through N-1 of segment 208 are conveyed over the broadcast channel successively and without interruption by acknowledgement messages. Once sections 1 through N-1 have been conveyed over the broadcast channel, the OLT 307 transmits the ACK section packet 350 over the unicast channel interface 214 (FIG. 2) over a unicast channel to the ONT 302. The ACK section packet 350 includes the N^{th} section (213 of segment 208), as well as an instruction field indicating that acknowledgement is required by the ONT 302. The OLT 307 separately transmits the same ACK section packet 352 over a unicast channel to ONT 303. The download section command 352 includes the N^{th} section 213 from the first segment 208, and an instruction field indicating that acknowledgement is require from the ONT 303. An ACK section packet 354 is transmitted with the N^{th} section 213 to the ONT 306.

The ACK sections packets 350, 352 and 354 include numbers identifying the position of the section 213 within the segment 208. Each ONT 302, 303 and 306 keeps track at the segment/section counters 268 of each of the incoming sections 210 and section 213. When the section counter 268 determines that it has received every section preceding the last section N, as well as section N, the segment/section counter 268 instructs the ACK/NACK reply module 272 to provide a download section response 356-358 acknowledging complete and proper receipt of all of the sections 210, 213 within the corresponding segment 208. The download section responses 356-358 are returned from each corresponding ONT 302, 303 and 306 including either an acknowledge (ACK) message or a un-acknowlededge (NACK) message. When all ONTs return ACK messages, the segment 208 is determined to be properly downloaded and flow returns to the top of FIG. 6, where the next segment (e.g., 209) is downloaded as section packets 340 and ACK section packet 350.

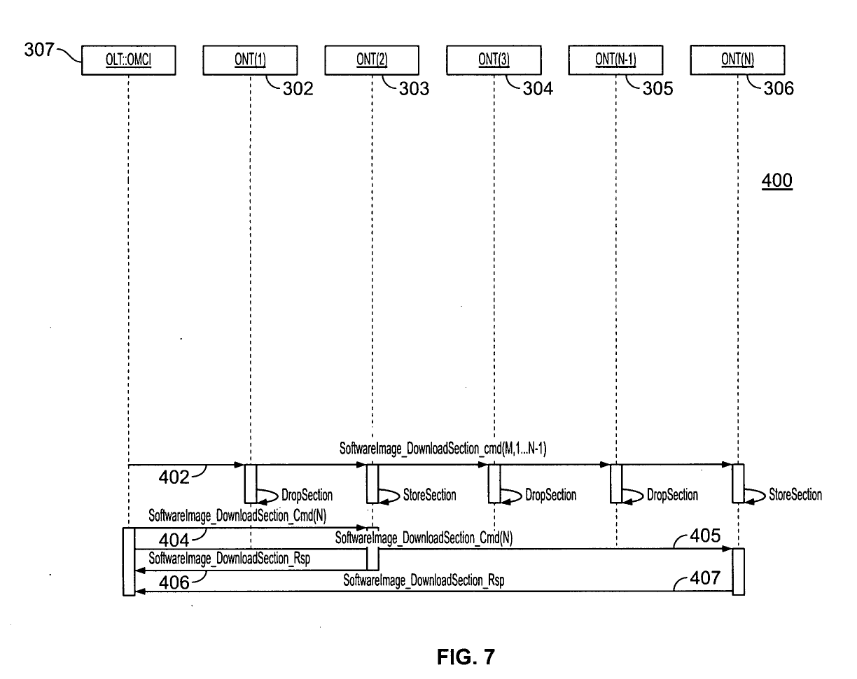

FIG. 7 illustrates a NACK instruction sequence 400 carried out whenever an ONT responds (e.g., at 256-358 in FIG. 6) with a NACK message, namely a non-acknowledged message, indicating that at least one of the sections 210, 213 of segment 208 was not correctly received at the ONT. When an ONT replies with a NACK message, the OLT 307 determines whether the ONT should be upgraded with the new software image. When it is determined that the ONT should still receive the upgrade or new software image, the OLT 307 initiates a “segment resend process” through which all of the sections 210, 213 of the NACK segment 208 are resent to the individual ONT that sent the NACK message. With reference to FIG. 2, the ONT ACK module 218 determines when one or more of the ONTs 202-206 have replied in a download section response 356-358 with a NACK message. When a NACK message is returned, control passes to the section NACK recovery manager 220. The section NACK recovery manager 220 instructs the unicast channel interface 214 to resend the complete segment 208, in connection with which an ONT has returned a NACK message.

The complete segment 208 may be resent, as a unicast NACK recovery operation, over the unicast channel associated with the ONT returning the NACK message. In a unicast recovery operation, the section NACK recovery manager 220 instructs 210 of the segment 208 as ACK section packets over the unicast channel associated with the NACKed ONT. Alternatively, the OLT 307 may perform a broadcast NACK recovery operation through the use of the broadcast channel interface 212. In this broadcast NACK recovery operation, the section NACK recovery manager 220 instructs the broadcast channel interface 212 to resend the sections 210 of the segment 208 in NON-ACK section packets 340 over the broadcast channel. The unicast channel interface 214 again only sends the N^{th} section 213 of segment 208 in an ACK section packet 350 over the unicast channel. The unicast channel interface 214 only sends the N^{th} section 213 over the unicast channel to the individual ONT that returned the NACK message.

In the example of FIG. 7, it is assumed that ONTs 303 and 306 returned a download section response 357 and 358 containing a NACK message indicating that the segment 208 was not properly received and uploaded. During the broadcast NACK recovery operation, the broadcast channel interface 212 sends the sections 210 of the segment 208 over the broadcast channel (as NON-ACK recovery section packets 402). Each of the ONTs 302-306 would receive sections 1 through N-1 of segment 208. However, only ONTs 303 and 306 process the sections. The ONT 302 received the original download of segment 208 correctly and thus would not be involved in the recovery process. Consequently, ONT 302 drops each of the sections 210 upon receipt during the recovery process of FIG. 7. The ONT 302 identifies the incoming section as corresponding to a segment that the ONT 302 has already properly received at section/segment counter 268. The ONT control module 270, upon receipt of each section, compares the section count and the segment count using counter 268 with the section and segment numbers within the incoming section packet. When the incoming section packet corresponds to a section that has already been uploaded, the ONT control module 270 drops the section packet.

Alternatively, when ONTs 303 and 306 do not properly receive each of the sections of segment 208 in the original broadcast sequence 340, the ONTs 303 and 306 reply with NACK messages indicating that the segment 208 was not properly uploaded. Hence, the segment/section counters 268 within ONTs 303 and 306 would reflect that the segment 208 was not properly stored in memory 252. Consequently, during the broadcast NACK recovery operations, the ONTs 303 and 306 would also store the sections 210 (1-N-1) conveyed over the broadcast interface 212. Upon completion of the rebroadcast of the sections 1-N-1, the section NACK recovery manager 220 instructs the unicast channel interface 214 to again transmit section N 213 over the unicast channels to the NACK ONTs (e.g., 303 and 306). The unicast transmission of the N^{th} section 213 is indicated by ACK section packets 404 and 405 which are directed to the ONT 303 and ONT 306, respectively. ONT 303 provides a download section response 406, while ONT 306 replies with a download section response 407. When the download section responses 406 and 407 indicate that the segment 208 was properly received, an acknowledged reply is detected at the ONT ACK module 218. The ONT ACK module 218 then instructs the control module 204 to move to downloading of the next segment (e.g., 209).

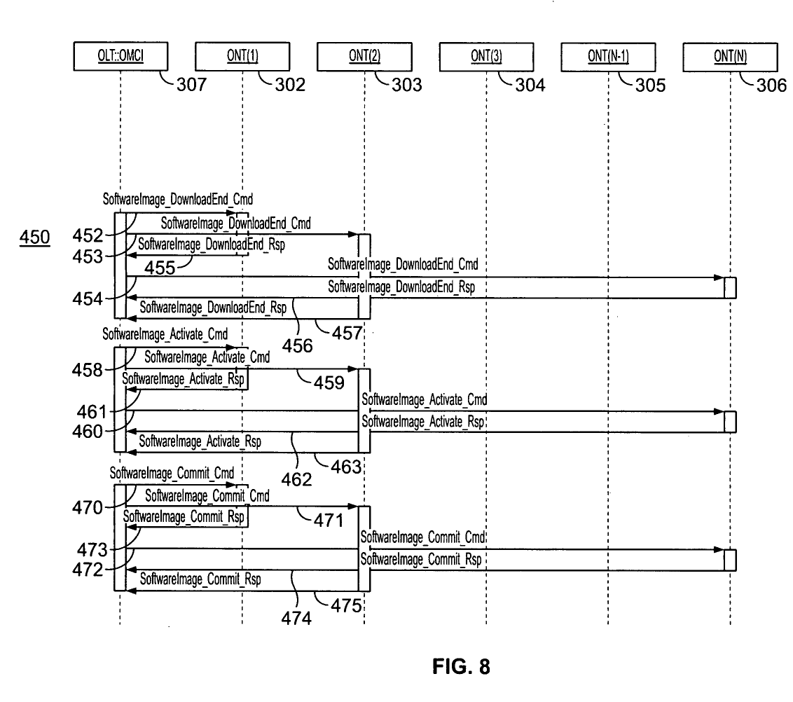

The above instruction sequences of FIGS. 6 and 7 are repeated for each segment 209, 211 in the software image 206. Once the complete software image 206 is successfully downloaded to each select ONT, flow moves to the instruction sequence of FIG. 8.

FIG. 8 illustrates the instruction sequence used to complete a download operation, active a software image and commit each ONT to the new software image. The OLT 307 provides a download end command 452 to ONT 302 and download end commands 53 and 454 to ONTs 303 and 306. The ONTs 302, 303 and 306 provide download end responses 455-457 indicating that the ONTs 302, 303 and 306 have received and will act upon the instructions to end the software image download process. The OLT 307 next transmits activate commands 458-460 to the ONTs 302, 303 and 306. The activate commands instruct the corresponding ONTs 302, 303 and 306 to load and run the newly uploaded software image 206. When the new software image 206 is correctly loaded and run, the ONTs 302, 303 and 306 provide activate responses 361-363 to the OLT 307 indicating that the software image 206 was properly loaded and successfully run.

Once the software image 206 is properly loaded and run on each of the ONTs 302, 303 and 306, the OLT 307 then transmits commit commands 470-472 to the corresponding ONTs 302, 303 and 306. In response to a commit command 470-472, the ONTs 302, 303 and 306 update corresponding configurations such that the newly uploaded software image will be utilized thereafter in subsequent corresponding applications. Once the software image 206 is committed successfully at each ONTs 302, 303 and 306, the ONTs 302, 303 and 306 provide commit responses 473-475 indicating whether the software image 206 was successfully committed.

When any of the ONTs 302, 303 and 306 reply with a NACK response to any of the download end response 455-457, activate response 461-463, or commit response 473-475, the OLT 307 nullifies the upgrade of the software image 207 for the corresponding ONT that replied with the NACK response. The OLT 307 may then repeat the download process for the complete software image 206 beginning at the download start command. The repeated operation may be preformed through a broadcast upgrade process or through a unicast upgrade process to an individual ONT.

When any reboot of OMCC linked failure occurs for an ONT during any stage of the upgrade sequence, the OLT 307 may immediately remove the corresponding ONT from the download group. The removed ONT may become eligible for a complete re-download, beginning from the download start sequence, once connection to the ONT had been reestablished.

In the foregoing description, the description is with reference to specific example embodiments thereof. It will, however, be evident that various modifications and changes may be made thereto, without departing from the broader spirit and scope of the present invention. For example, embodiments may be provided as a computer program product, or software, that may include a machine-readable medium having stored thereon instructions. Further, a machine-readable medium may be used to program a computer system or other electronic device and the readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. The specification and drawings are accordingly to be regarded in an illustrative rather than in a restrictive sense.

While the invention has been described in terms of various specific embodiments, those skilled in the art will recognize that the invention can be practiced with modification within the spirit and scope of the claims.

1. A method for managing a transfer of a software image to ONTs over a PON network, comprising:
dividing a software image into multiple segments, wherein each segment includes non-acknowledged (NON-ACK) and acknowledged (ACK) sections;
downloading NON-ACK sections of a first segment successively, over a common broadcast channel to a group of ONTs, in an unacknowledged manner; and
downloading an ACK section of the first segment over unicast channels to the group of ONTs in an acknowledged manner.

2. The method of claim 1, wherein each of the ONTs in the group of ONTs returns one of an acknowledgement (ACK) message and an unacknowledgement (NACK) message in connection with the ACK section.

3. The method of claim 1, further comprising configuring each ONT with an OMCI broadcast channel and an OMCI unicast channel.

4. The method of claim 1, wherein the ONTs in the group of ONTs do not return acknowledgement messages in connection with the NON-ACK sections downloaded over the broadcast channel.

5. The method of claim 1, wherein the first segment includes N sections and the ACK section constitutes an N^{th} section in the first segment.

6. The method of claim 1, further comprising sending a download start message only to ONTs that are to receive a common software image.

7. The method of claim 1, further comprising returning a NACK message when an ONT in the group of ONTs does not properly receive all of the sections in the segment.

8. The method of claim 1, further comprising identifying a NACK ONT from the group of ONTs that did not properly receive all of the NON-ACK and ACK sections and re-downloading all of the NON-ACK sections over the corresponding unicast channel of the NACK ONT.

9. The method of claim 1, further comprising identifying a NACK ONT in the group of ONTs that does not properly receive all of the NON-ACK and ACK sections and re-downloading all of the NON-ACK sections over the broadcast channel and the ACK section over the corresponding unicast channels for the NACK ONTs.

10. The method of claim 1, wherein the NON-ACK and ACK sections are transmitted in accordance with the ONT management and control interface protocol as defined in ITU 983.2 and 983.4.

11. The method of claim 1, further comprising, upon completion of a valid transfer of all segments in the software image, instructing the ONTs in the group of ONTs to activate and commit to the software image.

12. A system for managing a transfer of a software image to ONTs over a PON network, comprising:
a control module to divide a software image into segments and to divide the segments into non-acknowledged (NON-ACK) and acknowledged (ACK) sections;
a broadcast channel interface to transmit NON-ACK sections, over a broadcast channel to a group of ONTs, of a first segment in an unacknowledged manner; and
a unicast channel interface to transmit in an acknowledged manner, over a unicast channel to the group of ONTs, an ACK section of the first segment.

13. The system of claim 12, wherein the first segment includes N sections, the broadcast channel interface to transmit N-1 sections, the unicast channel interface transmitting an N^{th} section in the first segment.

14. The system of claim 12, further comprising an ONT select module to send a download start message only to ONTs that are to receive a common software image.

15. The system of claim 12, further comprising an ONT ACK monitor module to wait for ACK and NACK messages from each ONT in the group of ONTs after transmission of the ACK sections over the unicast channels.

16. The system of claim 12, further comprising a NACK section retransmit manager to identify a NACK ONT from the group of ONTs that did not properly receive all of the NON-ACK and ACK sections and re-downloading all of the unacknowledged sections over the corresponding unicast channel of the NACK ONT.

17. The system of claim 12, further comprising a NACK section retransmit manager to identify a NACK ONT from the group of ONTs that did not properly receive all of the unacknowledged and acknowledged sections and to re-download the first segment entirely only to the NACK ONT over the broadcast channel.

18. In an optical line terminal (OLT) that communicates with ONTs over a PON network, a computer readable medium configured to direct the OLT to manage a transfer of a software image having a first segment divided into non-acknowledged (NON-ACK) and acknowledged (ACK) sections, the computer readable medium comprising:
instructions directing download of NON-ACK sections of a first segment successively, over a common broadcast channel to a group of ONTs, in an unacknowledged manner;
instructions directing download of an ACK section of the first segment over unicast channels to the group of ONTs in an acknowledged manner;

19. The complete readable medium of claim 18, further comprising instructions for configuring each ONT with an OMCI broadcast channel and an OMCI unicast channel.

20. The complete readable medium of claim 18, further comprising instructions for sending a download start message only to ONTs that are to receive a common software image.

21. The complete readable medium of claim 18, further comprising instructions for identifying NACK ONT from the group of ONTs that did not properly receive all of the NON-ACK and ACK sections and re-downloading all of the NON-ACK sections over the corresponding unicast channel of the NACK ONT.

22. The complete readable medium of claim 18, further comprising instructions for identifying a NACK ONT in the group of ONTs that does not properly receive all of the NON-ACK and ACK sections and re-downloading all of the NON-ACK sections over the broadcast channel and the ACK section over the corresponding unicast channels for the NACK ONTs.

23. The complete readable medium of claim 18, further comprising instructions that upon completion of a valid transfer of all segments in the software image, instruct the ONTs in the group of ONTs to activate and commit to the software image.
